(19) United States
(12) Patent Application Publication
(10) Pub. No.: US 2004/0093445 A1
(43) Pub. Date: May 13, 2004

(54) Method and apparatus for infrared remote power up of a computer system

(75) Inventor: Szu-Chung Wang, Taipei (TW)

Correspondence Address: QUINTERO LAW OFFICE, 1617 BROADWAY, 3RD FLOOR, SANTA MONICA, CA, 90404, US

(73) Assignee: Mitac Technology Corp.

(21) Appl. No.: 10/350,985

(22) Filed: Jan. 24, 2003

(30) Foreign Application Priority Data
Nov. 13, 2002 (TW) 91133234

(51) Int. Cl. G06F 13/12

(52) U.S. Cl. 710/62

(57) ABSTRACT

A method and apparatus for remote infrared power up of a computer system. An infrared remote controller issues a first signal, received by a keyboard encoder in the computer system, which generates a second signal accordingly. The second signal is received by a power control pin, which activates a power control chip. Finally, a power controller in the power control chip powers up the computer system.

### BACKGROUND OF THE INVENTION

1. Field of the Invention

The present invention relates to a method and apparatus for infrared remote power up of a computer system, and in particular to a method and apparatus for infrared remote power up of a computer system without requiring manual power-on.

2. Description of the Related Art

Today, the remote control for electronic devices has become very ordinary. The widespread use the remote control units for TVs, VCRs, opening doors, and portable player control, etc. Hence, why not doing the same with the computer system?

Modern computer systems are versatile featuring numerous multimedia functions, such as TV and DVD playback function, Remote control provides considerable ease of operation. However, users are normally required to power-on the computer manually before remote function can be enabled. This is 2C inconvenient and negates the advantage of remote control.

### SUMMARY OF THE INVENTION

Accordingly, an object of the present invention is to provide a method and apparatus for infrared remote power up of a computer system, in which, even when the system is powered down, activation of an infrared remote controller powers the system up.

To achieve the above object, the present invention provides a method and apparatus for infrared remote power up of a computer system. First, the infrared remote controller issues a first signal, received by a keyboard encoder in the computer system, which generates a second signal accordingly. Thereafter, according to the second signal, a power control pin activates a power control chip comprising a power controller, which in turn powers up the computer system.

According to the present invention, the apparatus for infrared remote power up of a computer system includes an infrared remote controller, a keyboard, a power control pin, an infrared receiver, a power control chip, and a power controller.

The infrared remote controller generates a first signal, received by a keyboard encoder's integral infrared receiver, then generating a second signal accordingly. The power control pin is coupled to the infrared receiver and receives the second signal. The power control chip, equipped with a power controller, is coupled to the power control pin and, after receiving the second signal, powers up the computer system.

### BRIEF DESCRIPTION OF THE DRAWINGS

The present invention can be more fully understood by reading the subsequent detailed description and examples with references made to the accompanying drawings, wherein;

FIG. 1 is a flowchart illustrating the method for infrared remote power up of a computer system according to the present invention; and

FIG. 2 is a schematic diagram showing the architecture of the apparatus for remote infrared power up of a computer system according to the present invention.

### DETAILED DESCRIPTION OF THE INVENTION

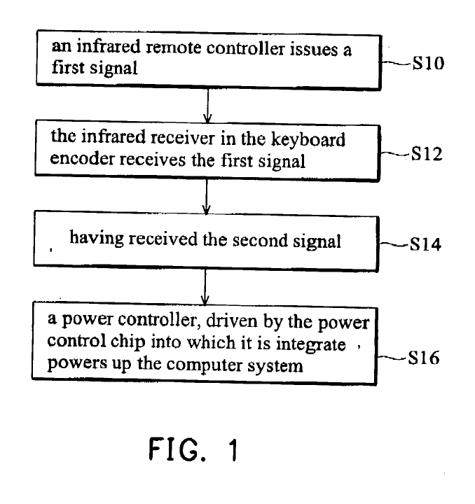

FIG. 1 illustrates the method for infrared remote power up of a computer system according to the present invention.

First, in step S10, an infrared remote controller issues a first signal, integrating a search function to locate a system equipped with a compatible infrared receiver, within a predetermined period of time. Then, in step S12, the infrared receiver in the keyboard encoder receives the first signal and the encoder generates a second signal.

In step 914, having received the second signal, a power control pin activates a power control chip.

Finally, in step S16, a power controller, driven by the power control chip into which it is integrated, powers up the computer system.

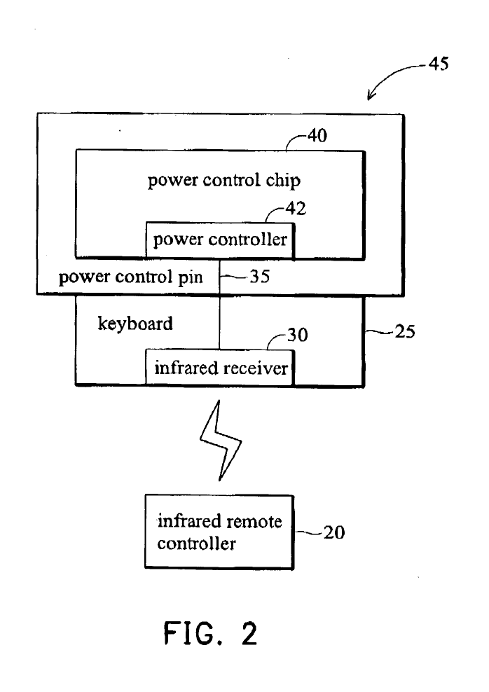

FIG. 2 shows the architecture of the apparatus for remote infrared power up of a computer system according to the present invention.

The apparatus for remote infrared power up of a computer system 45 includes an infrared remote controller 20, a keyboard 25, a power control pin 35, an infrared receiver 30, a power control chip 40, and a power controller 42. The infrared remote controller 20 integrates a search function, enabling it to locate and subsequently activate a compatible receiver. In the inventive apparatus, the infrared receiver 30 is integrated into a keyboard encoder in the keyboard 25. As well, a power control pin 35 is coupled to the infrared receiver 30 and the power controller 42 is integrated into the power control chip 40.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art) Therefore, the scope of the appended claims should be accorded the broadest interpretation so as to encompass all such modifications and similar arrangements.

What is claimed is:

1. A method for remote infrared power up of a computer system, comprising the steps of:
an infrared remote controller issuing a first signal which includes a search function to locate a compatible infrared receiver within a predetermined time period;
an infrared receiver in a keyboard of a computer system receiving the first signal;
the infrared receiver generating a second signal according to the first signal;
a power control pin receiving the second signal and subsequently activating a power control chip; and
a power controller integrated in the power control chip powering up the computer system.

2. An apparatus for infrared remote power up of a computer system, comprising:
an infrared remote controller for generating a first a signal;
a keyboard equipped with an infrared receiver for receiving the first signal and generating a second signal according to the first signal;
a power control pin coupled to the infrared receiver for receiving the second signal; and
a power control chip with integral power controller, to start the computer system according to receipt of the second signal.
